(19) United States
(12) Patent Application Publication
(10) Pub. No.: US 2026/0217312 A1
(43) Pub. Date: Jul. 30, 2026

(54) SENSOR DEVICE

(71) Applicant: LG INNOTEK CO., LTD., Seoul (KR)

(72) Inventor: Ho Min CHOI, Seoul (KR)

(73) Assignee: LG INNOTEK CO., LTD., Seoul (KR)

(21) Appl. No.: 19/144,378

(22) PCT Filed: Nov. 21, 2023
(86) PCT No.: PCT/KR2023/018734

§ 371 Date: Jun. 27, 2025

(30) Foreign Application Priority Data
Dec. 27, 2022 (KR) 10-2022-0185599

(51) Int. Cl. B62D 6/10; G01D 5/14; G01L 3/10; G01L 5/22

(52) U.S. Cl. CPC B62D 6/10; G01D 5/145; G01L 3/104; G01L 5/221; B60Y 2400/3012; B60Y 2400/307; B60Y 2410/10

(57) ABSTRACT

Provided in an embodiment is a sensor device comprising: a rotor; a stator disposed to correspond to the rotor; a first shield and a second shield that are disposed on one side of the stator; a first collector and a second collector that are disposed between the first shield and the second shield; a Hall sensor disposed between the first collector and the second collector; and a first housing and a second housing disposed on the outside of the first collector and the second collector, wherein: the first housing includes a first guide protruding from the outer surface of the first housing so as to form an accommodation space of the second shield on the inside thereof, and the second housing includes a second guide protruding from the outer surface the second housing so as to form an accommodation space of the first shield on the inside thereof; and the first housing includes a first cover disposed in the first guide so as to overlap in the axial direction of the second shield.

### TECHNICAL FIELD

Embodiments relate to a sensor device.

### BACKGROUND ART

A power steering system (an electronic power system, hereinafter referred to as an “EPS”) drives a motor by an electronic control unit according to driving conditions to ensure turning stability and provide rapid restoration, thereby enabling drivers to safely drive.

The EPS includes a sensor device that measures torque and a steering angle of a steering shaft to provide appropriate torque. The sensor device is a device that measures the degree of twist of a torsion bar. The torsion bar includes an input shaft that connects the steering shaft to a handle, an output shaft connected to a power transmission component on a wheel side, and a member that connects the input shaft and the output shaft.

The sensor device includes a housing, a rotor, a stator including stator teeth, and a collector. In this case, the collector is disposed outside the stator teeth. Therefore, when an external magnetic field is generated, there is a problem that the collector acts as a path for the external magnetic field, affecting a magnetic flux value of the sensor. When the sensor is affected in this way, an output value of the sensor device changes, causing a problem in which the degree of twist of the torsion bar cannot be accurately measured.

Meanwhile, in the case of the sensor device, a shield may be mounted on an outer surface of the housing to reduce the effect of the external magnetic field, but, when the shield is lifted from the housing or its position changes due to an external impact, the lift and change may have a negative effect on the performance of the sensor device.

### DISCLOSURE

### Technical Problem

Embodiments are directed to providing a sensor device capable of preventing a sensor from being affected by external magnetism and preventing a position of a shield from being deformed.

### Technical Solution

An embodiment may provide a sensor device including a rotor, a stator disposed to correspond to the rotor, a first shield and a second shield disposed on one side of the stator, a first collector and a second collector disposed between the first shield and the second shield, a Hall sensor disposed between the first collector and the second collector, and a first housing and a second housing disposed on outer sides of the first collector and the second collector, in which the first housing includes a first guide protruding from an outer surface of the first housing and forming an accommodation space for the second shield on an inside thereof, the second housing includes a second guide protruding from an outer surface of the second housing and forming an accommodation space for the first shield on an inside thereof, and the first housing includes a first cover disposed on the first guide to overlap in an axial direction of the second shield.

### Advantageous Effects

In an embodiment, an external magnetic field is prevented from flowing toward a collector through a shield separated from the collector, and the external magnetic field is allowed to flow, so that a sensor is prevented from being affected by the external magnetic field.

In the embodiment, a guide for fixing the shield is provided, so that there is an advantage of preventing the shield from changing its position by being moved in a direction perpendicular to an axial direction by an external force.

In the embodiment, a cover covering the shield is provided, so that there is an advantage of preventing the shield from being moved and lifted in the axial direction by an external force.

In the embodiment, a chamfered surface is formed on the cover covering the shield, so that there is an advantage of guiding the shield not to be caught on the cover when the shield is inserted into the cover.

### DESCRIPTION OF DRAWINGS

FIG. 1 is a perspective view showing a sensor device according to an embodiment.

FIG. 2 is a perspective view showing an inside of the sensor device shown in FIG. 1.

FIG. 3 is a perspective view showing a first shield and a second shield of the sensor device shown in FIG. 1.

FIG. 4 is a view showing a state of the first shield, the second shield, a first collector, and a second collector before assembly.

FIG. 5 is a side view of an assembled state of the first shield, the second shield, the first collector, and the second collector.

FIG. 6 is a perspective view showing the first shield.

FIG. 7 is a perspective view showing the second shield.

FIG. 8 is a perspective view showing the first collector.

FIG. 9 is a perspective view showing the second collector.

FIG. 10 is a side cross-sectional view of one side of the sensor device shown in FIG. 1.

FIG. 11 is a side cross-sectional view of the other side of the sensor device shown in FIG. 1.

FIG. 12 is a view showing a magnetic field flow when there is no external magnetic field.

FIG. 13 is a view showing a magnetic field flow when there is an external magnetic field in an axial direction.

FIG. 14 is a view showing a magnetic field flow when there is an external magnetic field in a radial direction.

FIG. 15 is a perspective view of a sensor device showing a housing according to a modified example.

FIG. 16 is an exploded view of the housing and a first shield and a second shield.

FIG. 17 is a view showing a first guide and a first cover disposed in a first housing.

FIG. 18 is a view showing the second shield fixed by the first guide and the first cover.

FIG. 19 is a view showing a second guide disposed in a second housing.

FIG. 20 is a view showing the second shield fixed by the first guide and the first cover.

FIG. 21 is a view showing the first shield and a third housing.

FIG. 22 is a side cross-sectional view taken along line A-A of FIG. 15.

FIG. 23 is a view of a second housing according to a modified example including a second cover.

FIG. 24 is a view showing the third housing that prevents the first shield from being lifted or bent.

### MODES OF THE INVENTION

Hereinafter, a direction perpendicular to an axial direction of a sensor device is referred as a radial direction, and a direction along a circle with a radial radius centered on an axis is referred to as a circumferential direction.

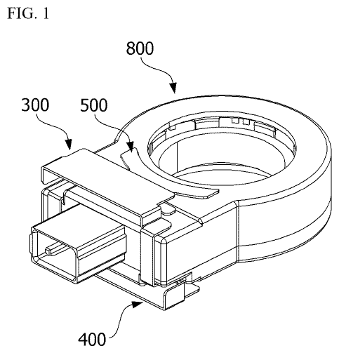

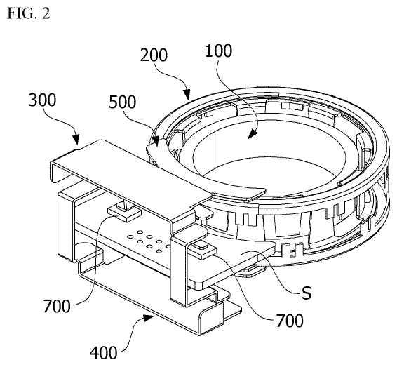

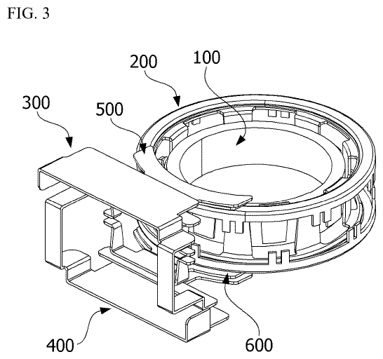

FIG. 1 is a perspective view showing a sensor device according to an embodiment, FIG. 2 is a perspective view showing an inside of the sensor device shown in FIG. 1, and FIG. 3 is a perspective view showing a first shield and a second shield of the sensor device shown in FIG. 1.

Referring to FIGS. 1 to 3, the sensor device according to the embodiment may include a rotor 100, a stator 200, a first shield 300, a second shield 400, a first collector 500, a second collector 600, and a Hall sensor 700. In the drawing, an x-axis represents a direction perpendicular to an axial direction, a y-axis represents a direction perpendicular to the axial direction and indicated by the x-axis, and a z-axis represents the axial direction.

Here, the stator 200 may be connected to an output shaft (not shown), and the rotor 100, at least a portion of which is rotatably disposed on the stator 200, may be connected to an input shaft (not shown), but is not necessarily limited thereto. In this time, the rotor 100 may be disposed to rotate with respect to the stator 200. Hereinafter, inside may refer to a direction disposed toward a center based on the radial direction, and outside may refer to a direction opposite to the inside.

The sensor device according to the embodiment has a feature that prevents an external magnetic field from affecting the Hall sensor 700 by guiding the external magnetic field to escape through the first shield 300 and the second shield 400 without flowing toward the first collector 500 or the second collector 600 in an environment where the external magnetic field operates.

The rotor 100 may include a magnet. The magnet may be disposed inside the stator 200. The magnet 210 may be connected to an input shaft through a separate holder.

A housing 10 is disposed outside the stator 200. A housing 80 may include an upper housing 11 and a lower housing 12. The stator 200, the first shield 300, the second shield 400, the first collector 500, and the second collector 600 may be fixed to the housing 80.

The first shield 300 may be disposed from a first side of the stator 200 toward a second side in an axial direction. The second shield 400 may be disposed from the second side of the stator 200 toward the first side in the axial direction. The first side refers to one side of the stator 200 in the axial direction, and the second side refers to the other side of the stator 200 in the axial direction.

The first collector 500 and the second collector 600 are each disposed to correspond to the Hall sensor 700.

A substrate S may be disposed between the first collector 500 and the second collector 600.

The Hall sensor 700 is disposed on the substrate S. The Hall sensor 700 is disposed between the first collector 500 and the second collector 600 to detect a change in the magnetic field generated between the stator 200 and the rotor 100, respectively. The Hall sensor 700 may be a Hall IC. Based on the detected change in the magnetic field, the sensor device measures torque.

The first shield 300 and the second shield 400 may have the same shape and size, but their positions may be different. The first collector 500 and the second collector 600 may have the same shape and size, but their positions may be different.

Based on the axial direction, the first collector 500 and the second collector 600 are each positioned between the first shield 300 and the second shield 400. Therefore, the first collector 500 and the second collector 600 may be protected from external magnetic fields through the first shield 300 and the second shield 400.

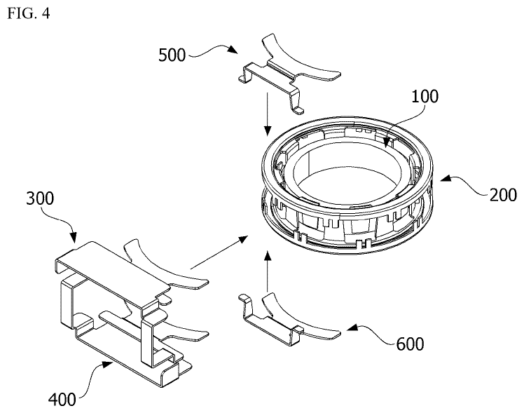

FIG. 4 is a view showing a state of the first shield 300, the second shield 400, the first collector 500, and the second collector 600 before assembly.

Referring to FIGS. 1 and 4, the first collector 500 is assembled to one side of the stator 200 in the axial direction. The second collector 600 is assembled on the other side of the stator 200 in the axial direction. The first shield 300 and the second shield 400 may be assembled outside the stator 200 in the radial direction. First, the first collector 500 and the second collector 600 are assembled into the housing 800, and then the first shield 300 and the second shield 400 may be inserted in the radial direction and assembled into the housing 800.

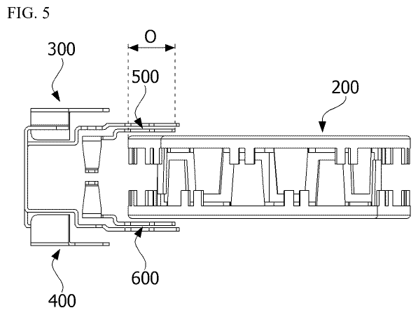

FIG. 5 is a side view of an assembled state of the first shield 300, the second shield 400, the first collector 500, and the second collector 600.

Referring to FIG. 5, the first shield 300 is disposed apart from the first collector 500 and the second collector 600. The second shield 400 is also disposed apart from the first collector 500 and the second collector 600. This is to prevent external magnetic fields from flowing toward the first collector 500 and second collector 600 through the first shield 300 or the second shield 400.

An inner end of the first shield 300 is disposed to overlap the stator 200 to form an axially overlapping region. An inner end of the second shield 400 is also disposed to overlap the stator 200 in the axial direction.

Based on the axial direction, the first collector 500 and the second collector 600 are disposed between the first shield 300 and the second shield 400.

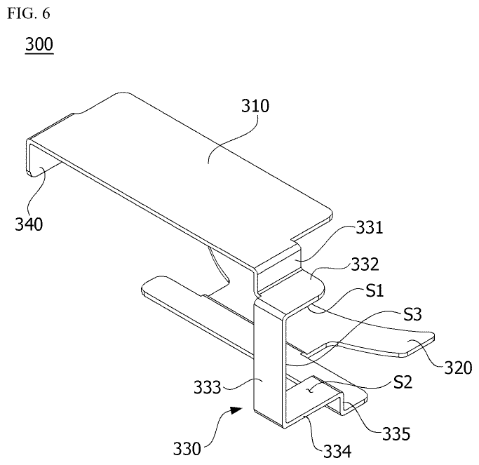

FIG. 6 is a perspective view showing the first shield 300.

Referring to FIG. 6, the first shield 300 includes a first region 310, a second region 320, a third region 330, and a first bent portion 340. The first region 310, the second region 320, the third region 330, and the first bent portion 340 are separately described, but they may be one member connected to each other.

The first region 310 is positioned on the first side of the stator 200. The first region 310 may be disposed along a plane perpendicular to the axial direction. As the size of the first region 310 increases, the effect of an external magnetic field may be reduced.

The second region 320 is positioned on the second side of the stator 200. The second region 320 may also be disposed along the plane perpendicular to the axial direction. An inner edge of the second region 320 has a curved surface.

The third region 330 connects the first region 310 and the second region 320. The third region 330 may include a plurality of bent regions. At least three of the plurality of bent portions of the third region 330 may have different bending directions.

For example, the third region 330 may include a first part 331 that is vertically bent downward from one side of the first region 310, and a second part 332 that is vertically bent from the first part 331. In addition, the third region 330 may include a third part 333 that is vertically bent downward from the second part 332, a fourth part 334 that is vertically bent from the third part 333 to be disposed to face the second part 332, and a fifth part 335 that is vertically bent downward from the fourth part 334 to be connected to the second region 320.

The second part 332 forms a first contact surface S1 that comes into contact with the housing 800. The fourth part 334 forms a second surface S2 that comes into contact with the housing 800. In addition, the third part 333 forms a third surface S3 that is connected to the first contact surface S1 and the second surface S2 when the third part 333 comes into contact with the housing 800.

The first bent portion 340 is bent downward from the other side of the first region 310. As the size of the first bent portion 340 increases, the effect of an external magnetic field may be reduced.

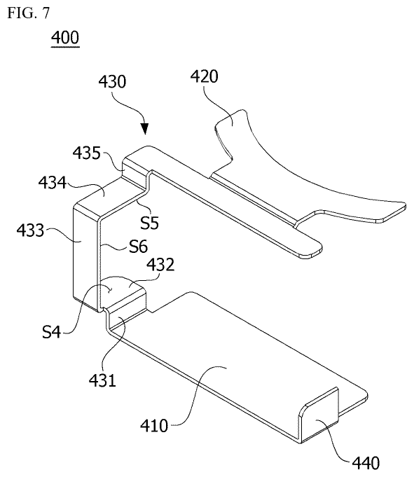

FIG. 7 is a perspective view showing the second shield 400.

Referring to FIG. 7, the second shield 400 includes a fourth region 410, a fifth region 420, a sixth region 430, and a second bent portion 440. The fourth region 410, the fifth region 420, the sixth region 430, and the second bent portion 440 are separately described, but they may be one member connected to each other.

The fourth region 410 is positioned on the second side of the stator 200. The fourth region 410 may be disposed along the plane perpendicular to the axial direction. As the size of the fourth region 410 increases, the effect of an external magnetic field may be reduced.

The fifth region 420 is positioned on the first side of the stator 200. The fifth region 420 may also be disposed along the plane perpendicular to the axial direction. An inner edge of the fifth region 420 has a curved surface.

The sixth region 430 connects the fourth region 410 and the fifth region 420. The sixth region 430 may include a plurality of bent regions. At least three of the plurality of bent regions of the sixth region 430 may have different bending directions.

For example, the sixth region 430 may include a sixth part 431 that is vertically bent downward from the other side of the fourth region 410, and a seventh part 432 that is vertically bent from the sixth part 431. In addition, the sixth region 430 may include an eighth part 433 that is vertically bent downward from the seventh part 432, a ninth part 434 that is vertically bent from the eighth part 433 to be disposed to face the seventh part 432, and a tenth part 435 that is vertically bent downward from the ninth part 434 to be connected to the fifth region 420.

The seventh part 432 forms a fourth surface S4 that comes into contact with the housing 800. The ninth part 434 forms a fifth surface S5 that comes into contact with the housing 800. In addition, the eighth part 433 forms a sixth surface S6 that is connected to the fourth surface S4 and the fifth surface S5 when the eighth part 433 comes into contact with the housing 800.

The second bent portion 440 is bent upward from one side of the fourth region 410. As the size of the second bent portion 440 increases, the effect of an external magnetic field may be reduced.

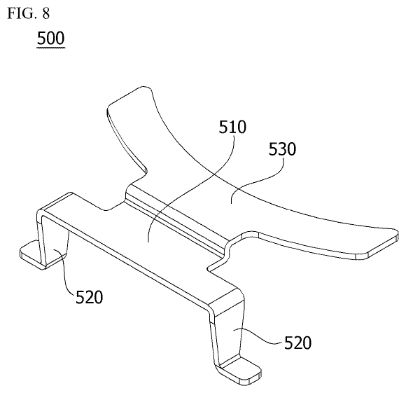

FIG. 8 is a perspective view showing the first collector 500.

Referring to FIG. 8, the first collector 500 may include a first body 510, a first leg 520, and a first extension 530. The first leg 520 is disposed to be bent downward on both sides of the first body 510 to face the Hall sensor 700. The first extension 530 extends into the first body 510. The first extension 530 is disposed to overlap the stator 200 in the axial direction. An inner edge of the first extension 530 is formed in a curved surface.

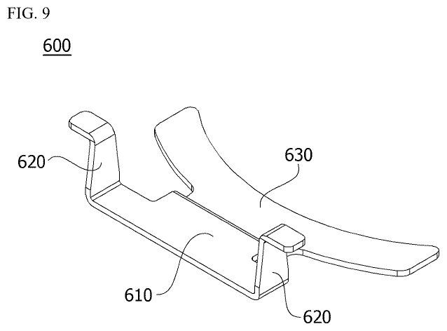

FIG. 9 is a perspective view showing the second collector 600.

Referring to FIG. 9, the second collector 600 may include a second body 610, a second leg 620, and a second extension 630. The second leg 620 is disposed to be bent downward on both sides of the second body 610 to face the Hall sensor 700. The second extension 630 extends into the second body 610. The second extension 630 is disposed to overlap the stator 200 in the axial direction. An inner edge of the second extension 630 is formed in a curved surface.

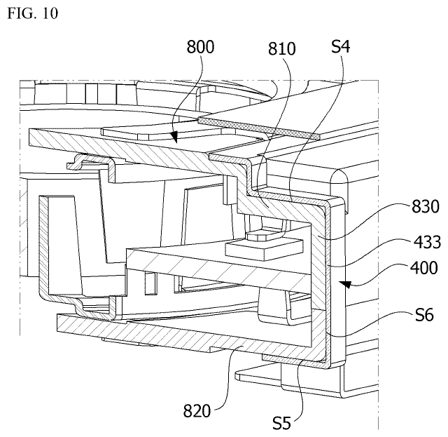

FIG. 10 is a side cross-sectional view of one side of the sensor device shown in FIG. 1.

Referring to FIGS. 6 and 10, the first shield 300 is disposed outside the housing 800. In addition, the first shield 300 comes into contact with an outer surface of the housing 800. The first contact surface S1 of the first shield 300 comes into contact with an upper surface 801 of the housing 800. The second surface S2 of the first shield 300 comes into contact with a lower surface 802 of the housing 800. In addition, the third surface S3 of the first shield 300 comes into contact with the side surface 803 of the housing 800.

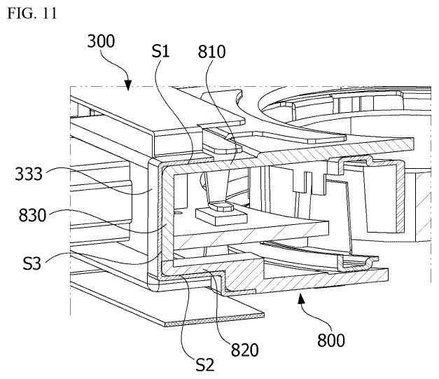

FIG. 11 is a side cross-sectional view of the other side of the sensor device shown in FIG. 1.

Referring to FIGS. 7 and 11, the second shield 400 is disposed outside the housing 800. In addition, the second shield 400 comes into contact with the outer surface of the housing 800. The fourth surface S4 of the second shield 400 comes into contact with the upper surface 801 of the housing 800. The fifth surface S5 of the second shield 400 comes into contact into the lower surface 802 of the housing 800. In addition, the sixth surface S6 of the second shield 400 comes into contact into the side surface 803 of the housing 800.

In this way, by each of the first shield 300 and the second shield 400 coming into contact with the side surface of the housing 800, each of the first shield 300 and the second shield 400 may be stably fixed to the housing 800.

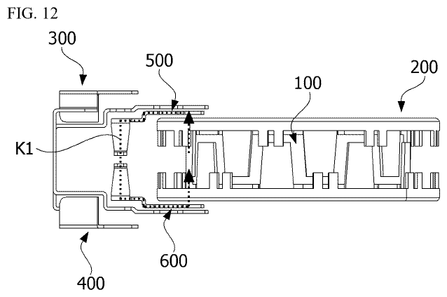

FIG. 12 is a view showing a magnetic field flow when there is no external magnetic field.

Referring to FIG. 12 (820), when there is no external magnetic field, the magnetic field flow that occurs between the rotor 100 and the stator 200 occurs only between the first collector 500 and the second collector 600, as in K1 of FIG. 12. The first collector 500 and the second collector 600 transmit the magnetic flow generated between the rotor 100 and the stator 200 to the Hall sensor 700.

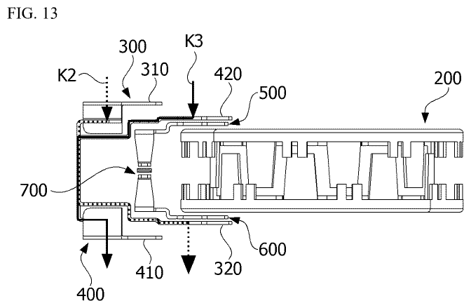

FIG. 13 is a view showing a magnetic field flow when there is an external magnetic field in an axial direction.

Referring to FIGS. 6 and 13 (820), when there is an external magnetic field in the axial direction, as shown in K2 of FIG. 13, the external magnetic field directed toward the first collector 500 and the second collector 600 at a position outside the stator 200 flows into the first region 310 of the first shield 300 and is guided to the second region 320 and escapes to the outside instead of flowing to the first collector 500 or the second collector 600.

When viewed in the axial direction, the first region 310 of the first shield 300 covers each of the first collector 500, the sensor 700, and the second collector 600. Specifically, the first region 310 is disposed to overlap the first body 510 and the second leg 520 of the first collector 500 in the axial direction. In addition, the first shield 300 is separated from the first collector 500. This may prevent the external magnetic field from flowing toward the first collector 500.

In addition, when there is an external magnetic field in the axial direction, as shown in K3 of FIG. 13, the external magnetic field directed toward the stator 200 flows into the fifth region 420 of the second shield 400 and is guided to the fourth region 410 and escapes to the outside instead of flowing to the first collector 500 or the second collector 600.

Since the second region 320 is disposed to overlap the second extension 630 of the second collector 600 in the axial direction, the second region 320 is separated from the second collector 600, the fourth region 410 is disposed to overlap the second body 610 and the second leg 620 in the axial direction, and the fourth region 410 is separated from the second collector 600, even when the external magnetic field is generated upward and downward in FIG. 13, the external magnetic field may be prevented from flowing to the first collector 500 or the second collector 600 as described above.

When viewed in the axial direction, since the fifth region 420 fully covers the first collector 500 and the first shield 300 is separated from the first collector 500, the external magnetic field directed toward the stator 200 may be prevented from flowing to the first collector 500.

In this case, the size of the fifth region 420 is formed to be greater than the size of the first extension 530 to cover the first extension 530 of the first collector 500 when viewed in the axial direction. In addition, the shape of the fifth region 420 may be formed to correspond to the shape of the first extension 530. Therefore, when viewed in the axial direction, the first shield 300 is disposed so that the first extension 530 is fully covered by the first region 310.

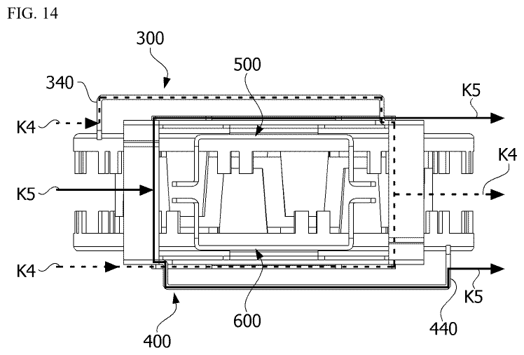

FIG. 14 is a view showing a magnetic field flow when there is an external magnetic field in a radial direction.

Referring to FIG. 14 (820), when there is an external magnetic field in the radial direction, as shown in K4 of FIG. 14, the external magnetic field directed toward the first collector 500 and the second collector 600 flows into the first bent portion 340 of the first shield 300 and is guided to the outside without flowing to the first collector 500 or the second collector 600.

In addition, another external magnetic field directed toward the first collector 500 and the second collector 600 flows into the second shield 400 and is guided to the second bent portion 440 and escapes to the outside without flowing to the first collector 500 or the second collector 600.

Table 1 below compares an offset of a sensing value according to an external magnetic field in a sensor device according to a comparative example and a sensing value according to the external magnetic field in the sensor device according to the embodiment.

Here, in the comparative example, the sensor device includes collectors disposed separately on the first side and the second side of the stator without a separate shield device. As shown in Table 1, in the case of an external magnetic field acting in a direction perpendicular to the axial direction (a first direction (x) and a second direction (y)), it may be confirmed that the offset of the sensing value of the comparative example and the offset of the sensing value of the embodiment are almost identical. However, in the case of an external magnetic field acting in the axial direction, the offset of the sensor device according to the embodiment is very low, at 1/40 of the offset of the sensing value according to the comparative example, so that it may be confirmed that the effect of the external magnetic field acting in the axial direction is relatively small in the embodiment compared to the comparative example.

TABLE 1

| | | Comparative | |
|---|---|---|---|
| | | Example | Example |
| Offset (deg) | First | 0.00 deg | 0.01 deg |
| of sensing | direction (x) | | |
| value | Second | 0.02 deg | 0.01 deg |
| corresponding | direction (y) | | |
| to external | Axial | 0.40 deg | 0.01 deg |
| magnetic field | direction (z) | | |

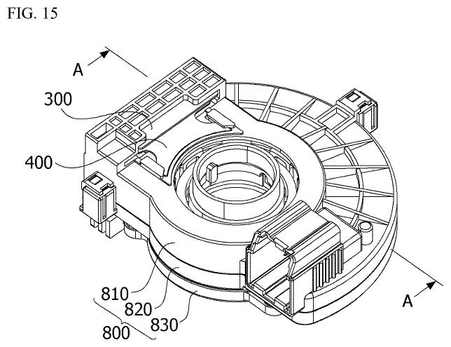

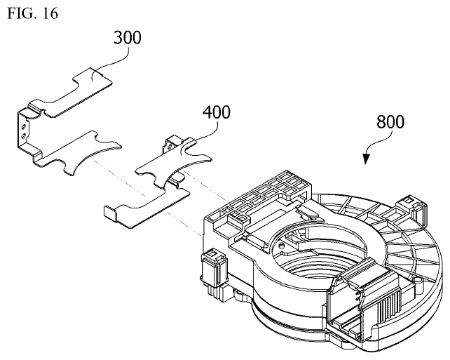

FIG. 15 is a perspective view of a sensor device showing a housing 800 according to a modified example, and FIG. 16 is an exploded view of the housing 800, a first shield 300, and a second shield 400.

Referring to FIGS. 15 and 16, the housing 800 may include a first housing 810, a second housing 820, and a third housing 830. The second housing 820 may be disposed between the first housing 810 and the second housing 820 in an axial direction.

The first shield 300 may be mounted on the housing 800 in a direction perpendicular to the axial direction. The second shield 400 may also be mounted on the housing 800 in the direction perpendicular to the axial direction.

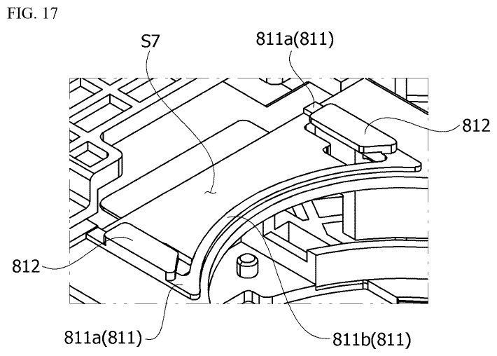

FIG. 17 is a view showing a first guide 811 and a first cover 812 disposed in the first housing 810.

Referring to FIG. 17, the first housing 810 may include a seventh surface S7 that comes into contact with the second shield 400 on an outer surface on one side thereof in the axial direction. The seventh surface S7 is disposed to face a fifth region 420 of the second shield 400. The seventh surface S7 may come into contact with the fifth region 420 of the second shield 400.

The first housing 810 includes a first guide 811. The first guide 811 serves to fix the fifth region 420 of the second shield 400 to the first housing 810, thereby preventing the second shield 400 from changing its position by the second shield 400 being moved in the direction perpendicular to the axial direction due to an external force.

This first guide 811 is disposed to protrude from the seventh surface S7 in the axial direction. The first guide 811 may include a first side guide 811a and a first inner guide 811b. This first guide 811 may have a shape corresponding to the shape of the fifth region 420 of the second shield 400.

A pair of first side guides 811a are disposed separately from each other. The first inner guide 811b is connected to ends of a pair of first side guides 811a. These first side guide 811a and first inner guide 811b form an accommodation space of the fifth region 420 of the second shield 400. The first side guide 811a may be disposed in a straight line corresponding to a side surface of the fifth region 420. The first inner guide 811b may be formed in a round shape corresponding to the inner edge of the fifth region 420.

When the second shield 400 is inserted into the first housing 810 in the direction perpendicular to the axial direction, the fifth region 420 is positioned inside the first guide 811 while moving along the seventh surface S7.

The first cover 812 may be disposed at an end of the first guide 811 in the axial direction. The first cover 812 is separated from the seventh surface S7 in the axial direction. The first cover 812 may be disposed to overlap the seventh surface S7 in the axial direction.

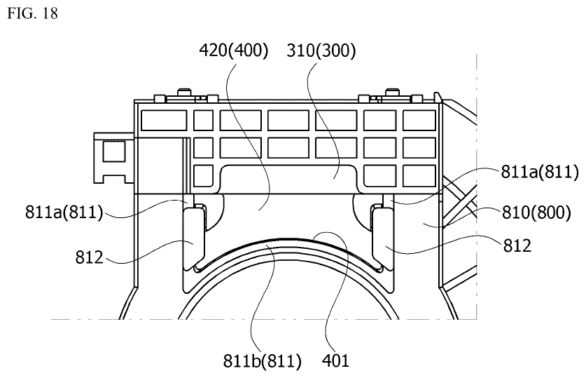

FIG. 18 is a view showing the second shield 400 fixed by the first guide 811 and the first cover 812.

Referring to FIGS. 17 and 18, the first side guide 811a is disposed to face the side surface of the fifth region 420 to be able to come into contact with the side surface of the fifth region 420. The first inner guide 811b is disposed to face an inner edge 401 of the fifth region 420 to be able to come into contact with the inner edge 401 of the fifth region 420. This first guide 811 fixes the second shield 400 so that the second shield 400 is not moved in the direction perpendicular to the axial direction.

In addition, the first cover 812 is disposed to overlap the fifth region 420 in the axial direction to fix the second shield 400 in the axial direction, thereby preventing the second shield 400 from being lifted by an external force.

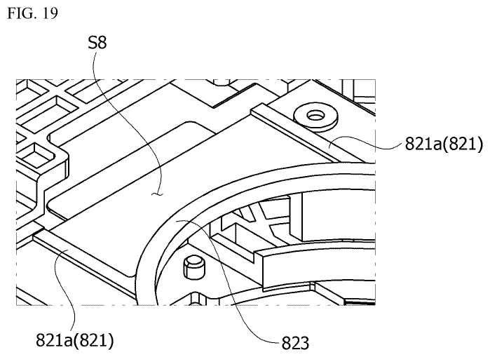

FIG. 19 is a view showing a second guide 821 disposed in the second housing 820.

Referring to FIG. 19, the second housing 820 may include an eighth surface S8 that comes into contact with the first shield 300 on an outer surface on one side thereof in the axial direction. The eighth surface S8 is disposed to face the second region 320 of the first shield 300. The eighth surface S8 may come into contact with the second region 320 of the first shield 300.

The second housing 820 includes the second guide 821. The second guide 821 serves to fix the second region 320 of the first shield 300 to the second housing 820, thereby preventing the first shield 300 from changing its position by the first shield 300 being moved in the direction perpendicular to the axial direction due to an external force.

This second guide 821 is disposed to protrude from the eighth surface S8 in the axial direction. The second guide 821 may include a second side guide 821a. The second guide 821 may have a shape corresponding to the shape of the second region 320 of the first shield 300.

A pair of second side guides 821a are disposed separately from each other. The second housing 820 may include a sliding portion 823. The sliding portion 823 is a portion that comes into contact with a main gear to guide the rotation of the main gear. The sliding portion 823 is connected to ends of a pair of second side guides 821a.

These second side guide 821a and sliding portion 823 form an accommodation space of the second region 320 of the first shield 300. The second side guide 821a may be disposed in a straight line corresponding to a side surface of the second region 320. The sliding portion 823 may be formed in a round shape.

When the first shield 300 is inserted into the second housing 820 in the direction perpendicular to the axial direction, the second region 320 is positioned inside the second guide 821 while moving along the eighth surface S8.

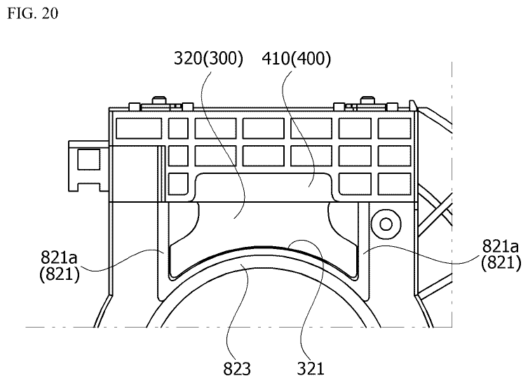

FIG. 20 is a view showing the second shield 400 fixed by the first guide 811 and the first cover 812.

Referring to FIGS. 19 and 20, the second side guide 821a is disposed to face the side surface of the second region 320 to be able to come into contact with the side surface. The sliding portion 823 is disposed to face an inner edge 321 of the second region 320 to be able to come into contact with the inner edge 321 of the second region 320. These second guide 821 and sliding portion 823 fix the first shield 300 so that the first shield 300 is not moved in the direction perpendicular to the axial direction.

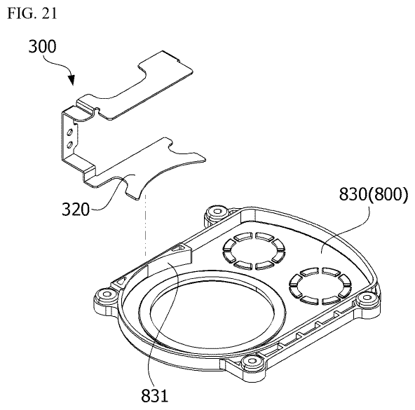

FIG. 21 is a view showing the first shield 300 and the third housing 830.

Referring to FIG. 21, the third housing 830 may include a third cover 831. The third cover 831 protrudes from an inner surface of the third housing 830 in the axial direction. The third cover 831 is disposed to overlap the second region 320 of the first shield 300 in the axial direction. When viewed in the axial direction, the shape of the third cover 831 may be disposed to correspond to the second region 320 as a whole.

This third cover 831 fixes the first shield 300 in the axial direction, thereby preventing the first shield 300 from being lifted by an external force.

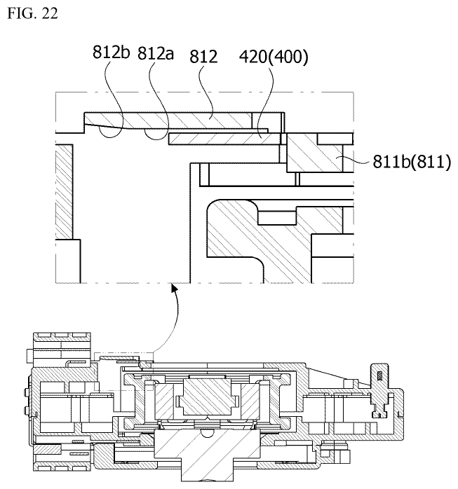

FIG. 22 is a side cross-sectional view taken along line A-A of FIG. 15.

Referring to FIG. 22, the first cover 812 of the first housing 810 includes a first inner surface 812a facing the first shield 300. In addition, the first inner surface 812a may include a first chamfered surface 812b. The first chamfered surface 812b may be formed to an outer end of the first cover 812. The first chamfered surface 812b is formed so that an axial thickness of the first cover 812 becomes smaller as the first cover 812 goes further outside the first cover 812. This first chamfered surface 812b has an advantage of guiding the second shield 400 not to be caught on the first cover 812 when the second shield 400 is inserted into the first cover 812.

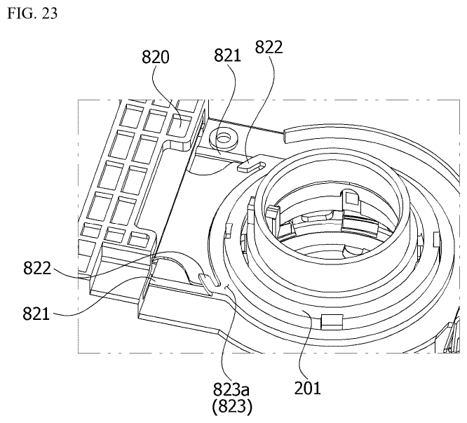

FIG. 23 is a view showing a second housing 820 according to a modified example including a second cover 822.

Referring to FIG. 23, the second housing 820 according to the modified example may include the second cover 822 together with the second guide 821. The second cover 822 replaces the third cover 831 of the third housing 830 to serve to prevent the first shield 300 from being lifted in the axial direction.

When the second housing 820 has the second cover 822, the third cover 831 of the third housing 830 may be omitted.

The second cover 822 may be disposed at an end of the second guide 821 in the axial direction. The second cover 822 is separated from the seventh surface S7 of the second housing 820 in the axial direction. The second cover 822 may be disposed to overlap the seventh surface S7 in the axial direction.

The second cover 822 is disposed to overlap the second region 320 in the axial direction to fix the first shield 300 in the axial direction, thereby preventing the first shield 300 from being lifted by an external force.

One surface of this second cover 822 may be disposed on the same plane as a sliding surface 823a of the sliding portion 823.

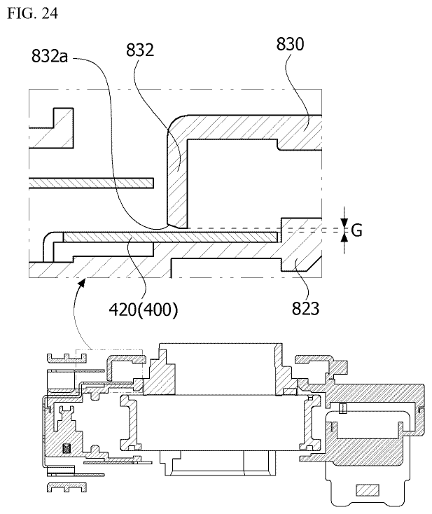

FIG. 24 is a view showing the third housing 830 that prevents the first shield 300 from being lifted or bent.

Referring to FIG. 24, the third housing 830 may include a side wall 832. The side wall 832 may be disposed to overlap the second region 320 of the first shield 300 in the axial direction. An end of the side wall 832 may be disposed adjacent to the second region 320 with a minimum gap G. Since this side wall 832 is positioned directly adjacent to the second region 320, it is possible to prevent the second region 320 from being lifted or bent in the axial direction. The end of the side wall 832 may include a second chamfered surface 832a. The second chamfered surface 832a may be formed to an outer end of the side wall 832.

The second chamfered surface has an advantage of guiding the first shield 300 not to be caught on the side wall 832 when the first shield 300 is inserted.

The above-described embodiment may be used in various devices such as vehicles or home appliances.

1.-10. (canceled)

11. A sensor device comprising:
a rotor;
a stator disposed to correspond to the rotor;
a first shield and a second shield disposed on one side of the stator;
a first collector and a second collector disposed between the first shield and the second shield;
a Hall sensor disposed between the first collector and the second collector; and
a first housing and a second housing disposed on outer sides of the first collector and the second collector,
wherein the first housing includes a first guide protruding from an outer surface of the first housing and forming an accommodation space for the second shield on an inside thereof, and
wherein the second housing includes a second guide protruding from an outer surface of the second housing and forming an accommodation space for the first shield on an inside thereof.

12. The sensor device of claim 11, the first housing includes a first cover disposed on the first guide to overlap in an axial direction of the second shield.

13. The sensor device of claim 12, wherein the first cover includes a first inner surface facing the second shield and the first inner surface includes a first chamfered surface formed to an outer end of the first cover.

14. The sensor device of claim 12, wherein the second housing includes a second cover disposed on the second guide to overlap the first shield in the axial direction.

15. The sensor device of claim 12, comprising a third housing coupled to the second housing,
wherein the third housing includes a third cover disposed to overlap the first shield disposed in the accommodation space of the second housing in the axial direction.

16. The sensor device of claim 14, wherein the second housing includes a sliding portion that comes into contact with a main gear coupled to a holder of the stator, and
wherein the second cover and the sliding portion are connected.

17. The sensor device of claim 16, wherein one surface of the second cover and a sliding surface of the sliding portion are disposed on the same plane.

18. The sensor device of claim 14, wherein the first shield includes a first region positioned on a first side of the stator in the axial direction, a second region positioned on a second side of the stator, and a third region connecting the first region and the second region, and
wherein the second shield includes a fourth region positioned on the second side of the stator in the axial direction, a fifth region positioned on the first side of the stator, and a sixth region connecting the fourth region and the fifth region.

19. The sensor device of claim 18, wherein the fifth region is disposed inside the first guide and overlaps the first cover in the axial direction.

20. The sensor device of claim 18, wherein the second region is disposed inside the second guide and overlaps the second cover in the axial direction.

21. The sensor device of claim 18, wherein the first guide includes a first side guide disposed to correspond to a side surface of the fifth region and an inner guide disposed to correspond to an inner edge of the fifth region, and
wherein the second guide includes a second side guide disposed to correspond to a side surface of the second region.

22. A sensor device comprising:
a stator;
a rotor rotatably disposed inside the stator and including a magnet;
a Hall sensor configured to detect a change in a magnetic field between the rotor and the stator;
a collector arranged to face each other with the stator interposed on one side and the Hall sensor interposed on the other side;
a shield provided to surround the collector to protect the collectors from external magnetic fields; and
a housing to which the shield is fixed,
wherein the housing includes:
a guide configured to restrict horizontal movement of a portion of the shield so that the portion of the shield is aligned with one side of the collector; and
a cover configured to restrict vertical movement of a portion of the shield.

23. The sensor device of claim 22, wherein the cover is formed integrally with the guide.

24. The sensor device of claim 22, wherein the housing includes a first housing, a second housing that secures the shield together with the first housing, and a third housing that is coupled to the second housing.

25. The sensor device of claim 24, wherein the cover is provided on the third housing.

26. The sensor device of claim 24, wherein the guide is formed in each of the first housing and the second housing.

27. The sensor device of claim 26, wherein the guide of the first housing is formed integrally with the cover.

28. The sensor device of claim 27, wherein the third housing is further provided with the cover.
